(19) United States
(12) Patent Application Publication
(10) Pub. No.: US 2001/0023457 A1
(43) Pub. Date: Sep. 20, 2001

(54) Advertising method using code image physically or electronically represented and apparatus thereof

(76) Inventors: Han Tack-don, Seoul (KR); Cheong Cheol-ho, Seoul (KR); Lee Nam-kyu, Goyang-city (KR); Shin Eun-dong, Seoul (KR)

Correspondence Address: NIXON & VANDERHYE P.C., 8th Floor, 1100 North Glebe Rd., Arlington, VA, 22201-4714, US

(21) Appl. No.: 09/758,212

(22) Filed: Jan. 12, 2001

(30) Foreign Application Priority Data
Mar. 14, 2000 (KR) 00-12748

(51) Int. Cl. G06F 15/16

(52) U.S. Cl. 709/245; 709/218

(57) ABSTRACT

An advertising method using a code image physically or electronically represented and an apparatus thereof are provided. According to the method, information for providing network services related to advertisements is physically or electronically represented by a code image in various advertising media, and a user can directly user network services provided by the advertiser, by clicking on the image or scanning or photographing the image with an optical input apparatus.

### BACKGROUND OF THE INVENTION

1. Field of the Invention

The present invention relates to an advertising service method, in which an advertiser effectively provides advertisements to consumers using communication networks such as the Internet, and an apparatus thereof, and more particularly, to an advertising service method for providing or receiving advertising services using a physically or electronically represented image code, and an apparatus thereof.

2. Description of the Related Art

These days, business model techniques are developed in diverse fields. Particularly, in line with the growing network environments and the Internet, a method for providing advertisements using the environments takes great interest. A banner advertisement, which is provided to users through web browsers, can bring an advertising effect only when a user actually clicks on the banner advertisement and watches the related web pages. However, most users are not interested in the banner advertisements and regard the advertisements annoyances. Therefore, compared to the advertising services using magazines, newspapers, leaflets, etc. in the existing physical environment, the advertising effect of the banner is very small.

Also, in some cases, the home pages or E-mail addresses of companies related to advertisements are appearing in physically printed advertising media. However, even after a user read the advertisement, if the user wants to visit the web site of advertising companies, the user frequently gives up to visit the site because the input method is difficult or annoying.

### SUMMARY OF THE INVENTION

To solve the above problems, it is an object of the present invention to provide an advertising method and apparatus in which a server provides encoding and decoding algorithms for an advertising code, a network address or index information is encoded to code information, and the code information is distributed as physical or electronic image data.

It is another object to provide an advertising method and apparatus in which a server provides encoding and decoding algorithms for an advertising code, and a code image distributed by an advertiser can be automatically decoded to provide services corresponding to the advertisement.

It is another object to provide a computer readable recording medium which stores a program for executing the method for performing the advertising service method in a computer.

To accomplish the above object of the present invention, there is provided an advertising method having the steps of the advertiser transmitting address information for providing services of a predetermined advertisement to a server; the server assigning index information to the address information and storing the address information and index information; and converting the address information or index information into a code image, which can be physically or electronically represented, by encoding the address information or index information using an encoding algorithm provided from the server.

It is preferable that the advertising method further having the step of distributing the code image in a printed state on a medium, in the form of a computer readable electronic file, in a state displayed on a screen, or in a state which can be input through an optical apparatus.

To accomplish another object of the present invention, there is also provided an advertising method having the steps of converting a code image related to an advertisement into computer readable code data; decoding the code data by a decoding algorithm and extracting code information contained in the code image; and executing a service program according to the code information and providing services preset for the advertisement.

It is preferable that the code image is an image formed of shapes, colors, patterns, or their combinations generated by converting one or more characters or numbers contained in the code information according to a predetermined code conversion table which maps each character and number to a predetermined color or shade.

To accomplish another object of the present invention, there is also provided an advertising method having the steps of assigning index information related to address information for providing advertising services; storing the address information and index information; converting the index information into a code image which can be physically or electronically represented, by encoding the index information by an encoding algorithm; and generating an advertising image in which the code image is physically or electronically represented together with the content image related to the advertisement.

To accomplish another object of the present invention, there is also provided an advertising service apparatus having a program in which an algorithm for encoding and decoding code information is implemented; an advertiser interface which is connected to an advertiser computer through a communication network, transmits the encoding program in response to the request from the advertiser computer, receiving address information related to an advertisement from the advertiser, and assigning index information corresponding to the address information; a user interface which is connected to a user computer through a communication network, transmits the decoding program in response to the request from the user computer, extracting code information from a code image transmitted from the user computer, and providing the code image to the user computer; and a database for storing the address information and index information assigned corresponding to the address information, in which the user computer is allowed to receive advertising services related to the advertisement according to the address information or index information.

To accomplish another object of the present invention, there is also provided an advertising service apparatus having a data processing unit for processing data by an algorithm for encoding and decoding data; an image generating unit for generating a code image physically or electronically represented by the encoding algorithm, using address information related to an advertisement as code information; a data generating unit for generating code data by converting the code image generated in the image generating unit into computer readable data; and a service providing unit for extracting code information by decoding the code data generated in the data generating unit by the decoding algorithm, and providing advertising services related to the advertisement according to the address information set by the code information.

### BRIEF DESCRIPTION OF THE DRAWINGS

The above objects and advantages of the present invention will become more apparent by describing in detail a preferred embodiment thereof with reference to the attached drawings in which:

FIG. 1 is the structure of a computer network system for performing the present invention;

FIG. 2 is a diagram for showing an example in which a code image is attached to an advertising content image for an advertising service;

FIG. 3 is an example of a code system for generating a code image;

FIGS. 4A and 4B are the structure of code information contained in a code image included in an advertising image;

FIG. 5 is a diagram for showing an example of the content stored in the address database 12A of a server 12;

FIG. 6 is a flowchart for explaining an embodiment of a method for generating an advertising image by an advertiser according to the present invention;

FIG. 7 is a flowchart for explaining a method in which a user receives advertising services from the advertising image distributed by an advertiser, according to the present invention; and

FIGS. 8 through 10 are schematic diagrams of various examples of the decoding method in the method explained in FIG. 7.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

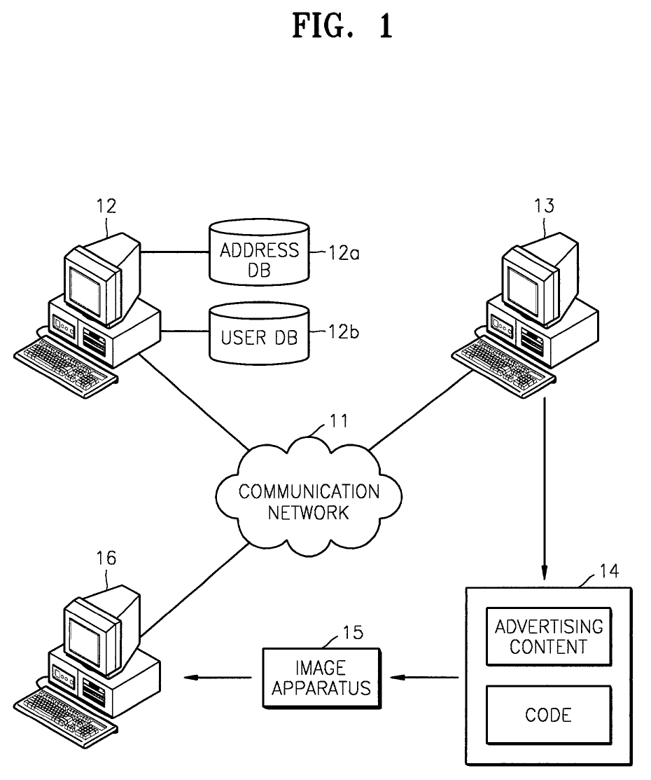

FIG. 1 is the structure of a computer network system for performing the present invention. A server computer 12 provides encoding and decoding algorithms for data related to advertising service, and has an address database 12A for storing address information corresponding to advertisements requested by advertisers and index information corresponding to the address information, and a user database 12B for storing information on users registered in the server computer 12. Here, the address information includes telephone numbers, fax numbers, network host addresses, Internet domain names and Internet protocol (IP) addresses, uniform resource locators (URLs), E-mail addresses and so on.

The server computer 12 provides algorithms related to advertising services and is installed in a company conducting advertising services, while a user computer 16 is owned by a user who can receive advertising services through the server computer 12. An advertiser computer 13 is owned by a person or a company who provides advertisements to the user using the server computer 12.

The server computer 12 has a program in which algorithms for encoding and decoding data are implemented, while the advertiser computer 13 encodes code information, which is formed of address information and/or index information related to the advertiser's advertisements, through an encoding algorithm, and generates and distributes an advertising medium 14 such as poster, handbill, electronic document, etc., containing a physically or electronically represented code image. A picture input apparatus 15 converts the code image of the advertising medium 14 distributed by the advertiser computer 13 into computer readable data to generate code data, and the user computer 16 decodes code data through a decoding algorithm to extract code information, and gets advertising services related to advertisements according to address information contained in the code information.

The server computer 12 has an address database 12A for storing address information such as the network address corresponding to advertisements requested by advertisers, and index information, which is assigned corresponding to the address information. If the information input to the user computer 16 is index information, the user computer 16 accesses the server computer 12 and receives address information which is stored in the address database 12A and is referred to by index information, and then may get advertising services related to the advertisements.

The server computer 12, the user computer 16, and the advertiser computer 13 are connected to each other through a communication network 11, and if necessary, communicate with each other. The user computers 16 connected to the communication network 11 have Internet browsers (for example, Netscape or Internet Explorer) which can display web contents encoded in Hyper Text Markup Language (HTML) or other languages. The web browser makes user computer 16 access the server computer 12 or the advertiser computer 13.

The server computer 12 controls the user computers 16 to receive advertising services according to advertiser's code information, and has programs in which algorithms for encoding and decoding code information in a predetermined method is implemented. The server computer 12 is connected to the advertiser computer 13 through a communication network, and transmits the encoding program in response to the request from the advertiser computer 13. Also the server computer 12 receives address information related to predetermined advertisements from advertisers, assigns index information for the address information, and stores the address information and index information. Alternatively, the server computer 12 can encode code information to convert it into an advertising image which can be physically represented, and then transmits the converted image to the advertiser computer 13. The server computer 12 has a user interface, through which the server computer 12 is connected to the user computer 16, and transmits the decoding program in response to the request from the user computers 16, or provides code information to the user computer 16, which is extracted from a code image transmitted from the user computer 16.

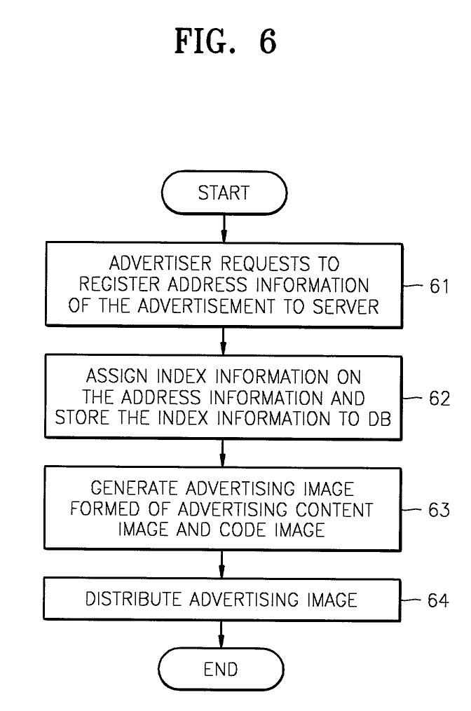

The advertiser computer 13 distributes an advertising medium containing code image, which is made from address information or index information for providing contents related to predetermined advertisements, together with ordinary advertising contents (Details related to this will be explained referring to FIG. 6).

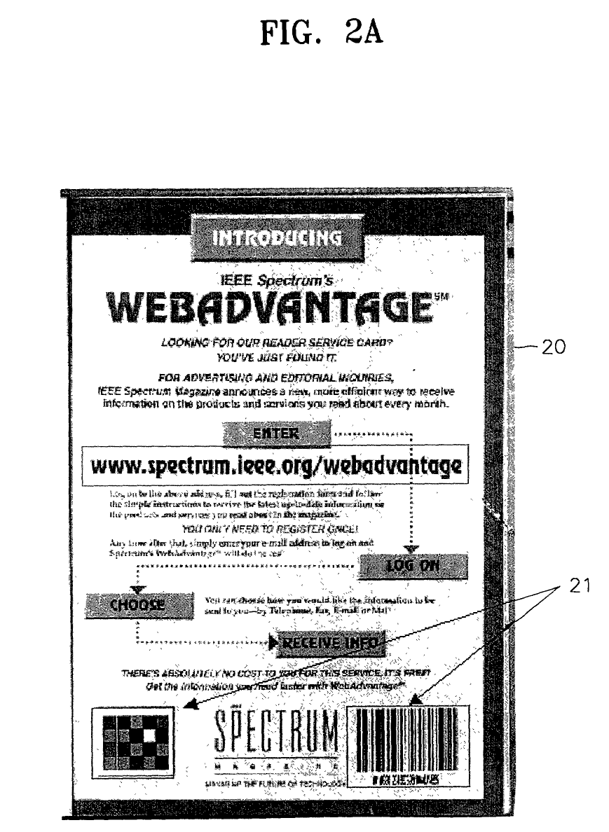

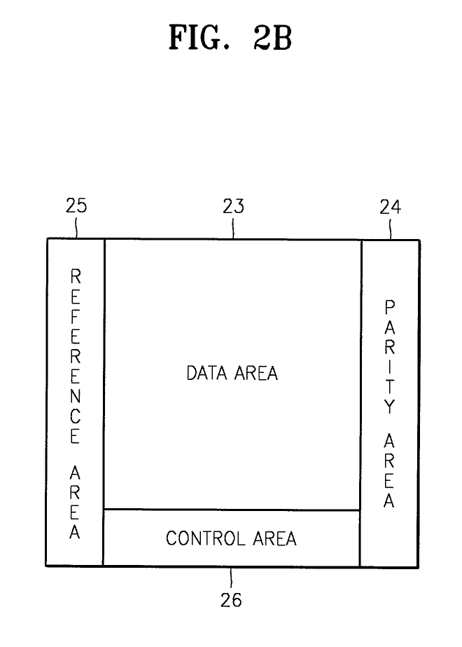

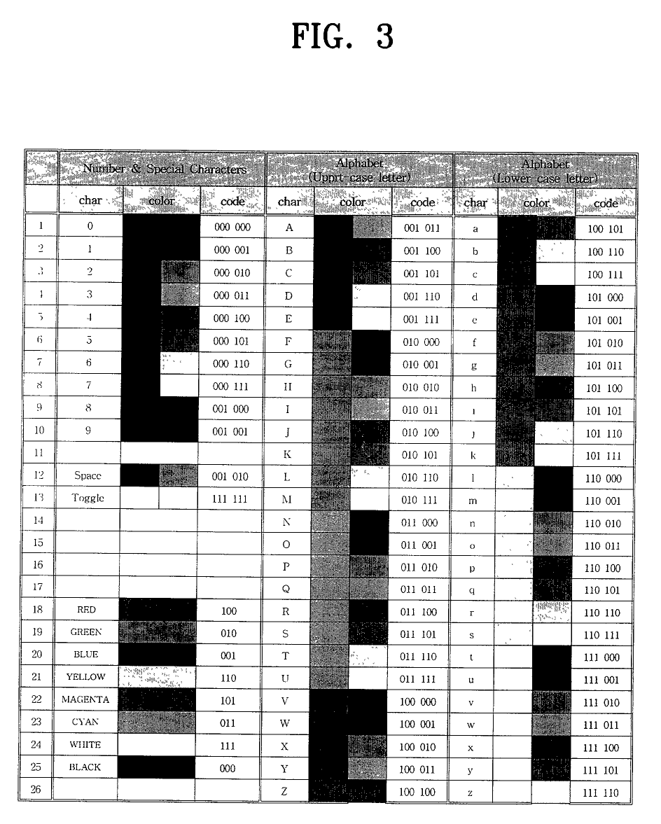

The code image is an image which is formed of predetermined shapes, colors, patterns, or their combinations (also including characters and numbers), which are generated by converting one or more characters or numbers included in code information (this is formed of address information and/or index information) according to a predetermined code conversion table which maps each character and number to a predetermined color or shade. The code image includes a matrix image formed of 1-dimensional or 2-dimensional monochrome or color cells(or lines). The code image may exist in the form of a visual picture, or in the form of file data which can be read by a computer. In the code image, “code information” which can be expressed as characters or numbers is included. A code system is a system that defines the relation between characters including numbers, and colors or shades set corresponding to the characters. FIG. 2 is a diagram for showing an example in which a code image is attached to an advertising content image for an advertising service, and FIG. 3 is an example of a code system for generating a code image.

The user computer 16 receives a physical code image or an electronic code image obtained from the advertising medium 14 through an image input apparatus 15, and stores the image in a memory, a hard disc, a buffer, or a screen. Here, the image input apparatus 15 is an optical apparatus which can obtain visual information from a physical object using light, and includes a PC camera, a digital camera, and a scanner. In addition to the input by the optical apparatus, an image file matching the code system can be generated by programming or graphic software. The user computer 16 decodes a code image to extract code information, and can use advertising services provided by an advertiser according to network information represented by the code information.

The server computer 12 has a program, in which algorithms for encoding data to generate a code image, and decoding the code image into original data, using colors, shades, or patterns, is implemented. The user computer 16 can download a program for decoding from the server computer 12 to use the program in directly decoding a code image, while the advertiser computer 13 can download a program for encoding from the server computer 12 to use the program in encoding code information into a code image. If the user computer 16 or the advertiser computer 13 does not download a program for decoding or encoding, the user computer 16 or the advertiser computer 13 can be made to be connected to the server computer 12 for decoding or encoding.

Here, the encoding method can be divided into a direct encoding method and an index (or indirect) encoding method. The direct encoding method is a method for converting a network address or URL address information itself into an image according to the code system (See FIG. 3), and at this time, code information is formed of address information. The index encoding method is a method for converting a key, which is used to refer to the server computer's database 12B having network addresses or URL addresses, into an image according to the code system, and at this time code information is formed of index information. An encoded code image can be made to be automatically output by the algorithm of a program, or can be made through a graphic editor or manual works according to the code conversion system.

Decoding means to find out original code information according to definition of a code system. The code information is formed of characters, numbers, special characters or their combinations, which can be expressed by a computer, and is address information and/or index information. The decoding method can be divided into a direct decoding method and an index (or indirect) decoding method according to an encoded method. In the direct decoding method, if a code image is decoded, address information such as a network address is directly extracted. In the index decoding method, the decoded result has a key value (index information) of the database having network address information.

In a decoding process, a process for finding out meaningful shapes, colors, patterns, and characters contained in a code image is needed, and a process for compensating a distorted image is also needed. Here, a color can be determined by using one or more models among a red, green, blue (RGB) model, a hue angle, saturation, value (HSV) model, a cyan, magenta, yellow (CMY) model and a hue angle, lightness, saturation (HLS) model.

An actual application of the advertising system will now be explained. An advertiser attaches or prints a code image, in which network address information and/or index information for specifying network address information are encoded, to various products, premiums or advertisements, and distributes those to users. The user who receives the code image decodes the code image so that he automatically accesses the network address, and can directly get services provided from the advertiser.

FIG. 3 is an example in which various characters (the alphabet or special characters) or numbers are converted into code images. For encoding, various characters are converted into codes, and colors assigned to corresponding codes forms a code image. In this example, 8 colors are used to form a code image, and continuous two cells are used to express a character or a number. For each color, any one code from “000” to “111” is assigned. For example, a code “000 011” is assigned for number “3”, and a color assigned to code “000” and a color assigned to “011” are used for encoding. Thus, an image for representing number “3” is formed of the two color cells.

Due to limit in drawing, FIG. 3 is expressed in monochrome grey level, but it is preferable that a combination of colors is used in an actual application. The number of colors will be determined by a color printing machine (for example, a printer) or a color recognition machine (for example, a scanner).

FIG. 2A is an example diagram of an advertising image physically represented which an advertiser provides to users. The advertising image includes an advertising content area for representing the advertising content itself, and a code image area for providing advertising services related to the advertisement. In FIG. 2A, an example (a first code image) of a code image formed of color codes is at the left bottom corner, and an example (a second code image) of a code image in the form of a bar code is at the right bottom corner.

FIG. 2B is a diagram of an example of the structure of the first code image or the second code image of FIG. 2B. The code image includes a data area 22, in which code information is represented as an image, and may additionally include at least one or more among a parity area 24, a reference area 25, and a control area 26. Each area of the code image has at least one or more cells. The number of cells included in the code image can be determined as needed. It is preferable that the structure of the code image is an N×M matrix type. However, considering user's need or the characteristic of a medium on which the code image is expressed, an arbitrary shape such as a circle or an oval shape can be adopted.

The data area 23 is formed of at least one or more data cell which is encoded with different colors or shades according to the content of code information. The parity area 24 is formed of parity cells for checking errors in recognizing cells represented in the data area 23. The reference area 25 is formed of at least one or more cells for providing base colors or base shades for determining colors or shades of data cells formed in the data area 23. The control area 26 is formed of at least one or more control cells for representing commands or services which can be provided using the code information represented in the data area 23. Also, it is preferable that boundary areas for distinguishing areas is included between each area included in the code image. Also, boundary areas for distinguishing cells can be further included between each cell included in each area. The boundary area can be formed of lines or cells having predetermined colors or patterns, or boundary lines or boundary areas can be formed of a black color or a white color.

The parity area 24 provides parity information for confirming whether or not the colors or shades read from data cells are correctly recognized during decoding. The parity area 24 is formed of parity cells, each of which is formed of colors or shades corresponding to parity data, after the parity data corresponding to colors or shades represented in data cells is obtained according to predetermined code values.

The reference area 25 is used to set base colors (or base shades) for recognizing colors (or shades) represented in cells in the data area 23 and/or the control area 26. A cell color represented in each area is represented based on at least one model among the RGB color model or HSV color model. Also, even when a code is formed by a monochrome shade (grey scale), information in each cell can be accurately recognized based on black and/or white represented in the reference area 25. Depending on models of a printer or materials of printing paper, a color can be differently printed, and depending on characteristic of a scanner or a camera, a color can be differently recognized. Considering this, a reference cell in the reference area 25 provides a base for determining colors represented in the data area 23.

In a code image, code information can be encoded using various colors, or using a grey scale code, that is, monochrome shades. The grey scale code is a code system in which a code is formed according to the brightness of white and black instead of the mixing ratio of red (R), green (G), and blue (B) forming colors. Therefore, the reference area is formed of at least one or more base shades among black, white and grey, and a cell in the data area has a value encoded by a grey difference compared with the base shades of the reference area. This grey code image can be applied to media printed in monochrome such as newspapers. Also, in converting code information into a code image, a pattern using a vector line can be added to a cell in addition to colors or shades.

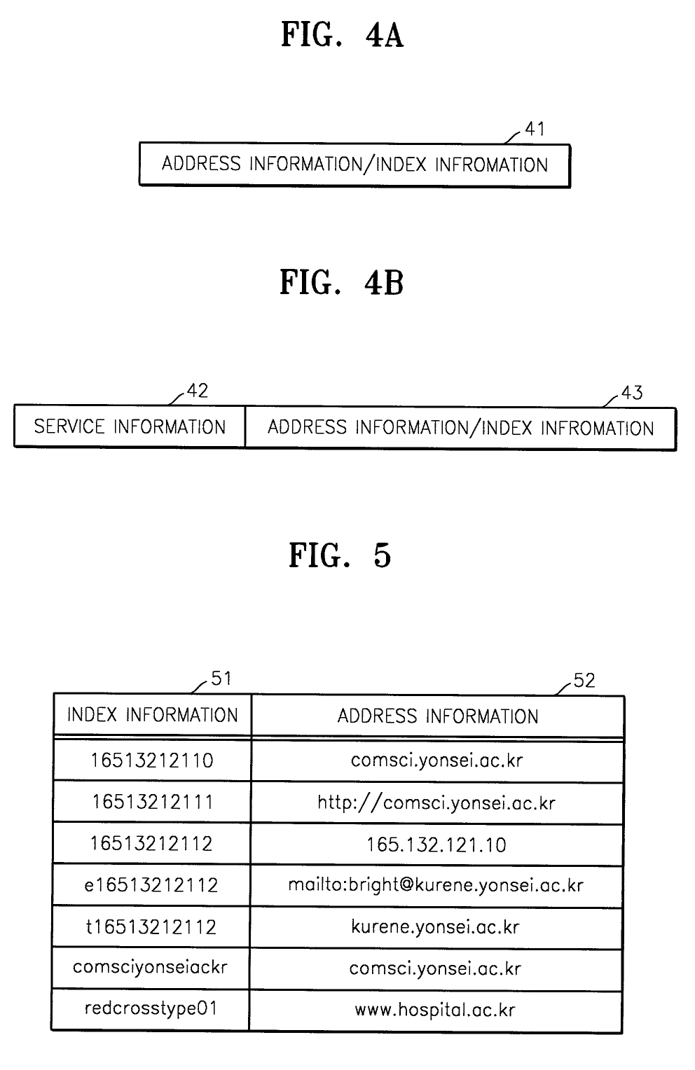

FIGS. 4A and 4B are examples of code information (information which a user obtains after decoding a code image) contained in a code image (See the first or second code image of FIG. 3). Code information includes address information and/or index information 41 and 43 for receiving network services, and can also include service information 42. If there is no service information, a service which is basically set in the decoding program is provided.

The address information is information which indicates an actual address, for example, a network address or a uniform resource locator (URL). The index information is information for searching a database in which actual addresses are stored. Here, a network address means an address indicating the location of a predetermined network apparatus in a network environment, such as an IP address or a domain name in the Internet. The URL is a format indicating a predetermined address in the Internet, and formed of a protocol, a network address, a directory, parameters, and special characters.

FIG. 4B shows an example in which code information includes address information and/or index information 43 together with service information 42. Service information is information which allows a user to directly get network services, for example, web services, telnet services, E-mail services, Gopher services, file transfer protocol (FTP), which can be used through communication protocols or communication apparatuses.

FIG. 5 is a diagram for showing an example of the content stored in the address database 12A of a server 12, which includes index information 51 and address information 52. Index information 51 is key value used in searching the address database 12A for address information 52 of a predetermined network apparatus. That is, for example, if “comsci” is input as index information, the server detects and outputs “comsci.yonsei.ac.kr”, the address information linked to the index information. If the actual address “comsci.yonsei.ac.kr” changed into other address, only by changing the content of address information 52 in the database, a user can obtain the changed new address information even with the previous index information. Meanwhile, the content referred to by index information can be functioned as index information for searching for other information, and in this case, the second index information can be used for detecting actual address information.

To refer to a destination computer through the Internet, an IP address and a domain name can be used. The sever-oriented service such as telnet needs only to refer to a computer, while document or file-oriented services such as world wide web (WWW) or FTP need to refer to a file stored in the computer. For this, URL (or uniform resource identifier, URI) is used, in which a server computer to be linked is represented by an IP address or domain name and a file to be referred to is represented by a file path. That is,

[protocol]://[server name]/[path]

For example, http://info.co.kr/infopub/index.htm.

Here, “http://” is a protocol (the content of a service) to be used in transmitting and receiving data (files). Here, the HyperText Transport Protocol (HTTP) is a protocol used in transmitting and receiving web documents in WWW. When a file is requested in an FTP server, “ftp” is used, while if a telnet server is linked, “telnet” is used. After the protocol, the IP address or domain name of a server to be linked is written. After the server name is represented, the path of the desired data is assigned. The path here means the directory and the file name, in which the data is stored in the server.

FIG. 6 is a flowchart for explaining an embodiment of a method for generating an advertising image according to the present invention. The server computer 12 for controlling advertising services is linked to an advertiser computer 13 through a communication network.

The advertiser sets a network address of web site, which is opened to provide advertisement-related information to be provided to consumers, or an E-mail address for receiving orders or consumers' opinions related to the advertisements, as address information, and then accesses the server computer 12 and requests to register the address information in step 61. The server computer 12 assigns unique index information to the address information of the advertisements and stores the index information and address information to the address database 12A in step 62.

The server computer 12 encodes address information and/or index information to a code image using an encoding algorithm, and then sends the code image to the advertiser computer 13. If the advertiser computer 13 has already downloaded and installed an encoding program provided by the server computer 12, the advertiser computer 13 can directly encode address information and/or index information to a code image using the encoding program. After generating an advertising image (See FIG. 2) including a content image and a code image related to the advertisement, the advertiser distributes the advertising image to consumers in step 64. The advertising image can be distributed after printed on a paper or printed or attached to other material objects, and can also be distributed in a computer readable state (for example, to be directly displayed on a monitor or to be in the form of an image file which can be read by an image editing program).

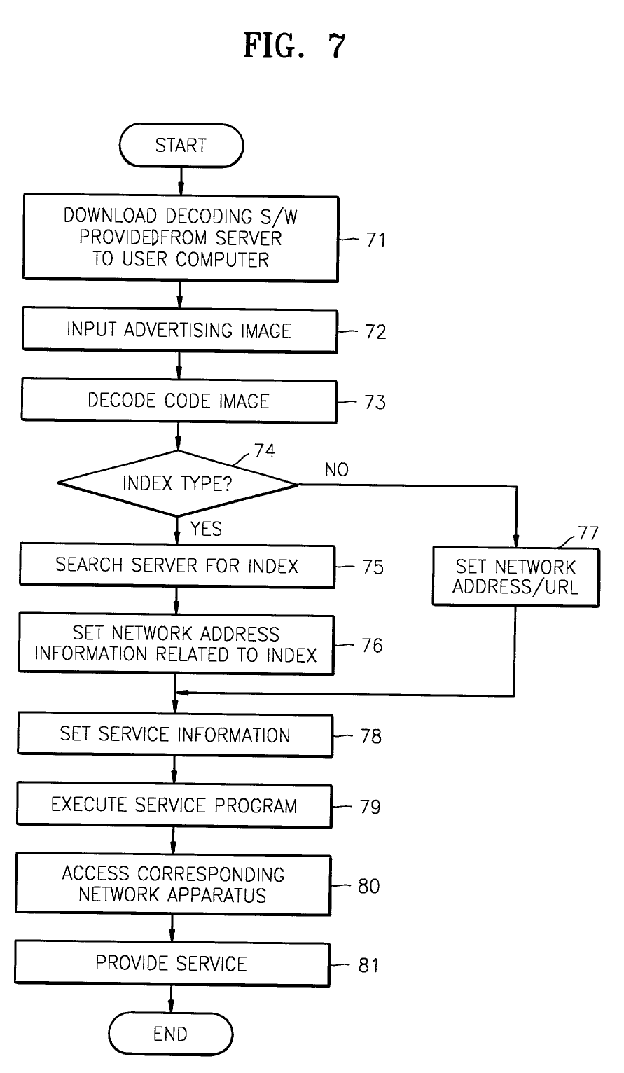

FIG. 7 is a flowchart for explaining a method in which a user receives advertising services from the advertising image distributed by an advertiser, according to the present invention. The user computer 16 downloads and installs a decoding program provided by the server computer 12 in step 71. At this time, the is user inputs his information such as ID, password, and address, to the server computer 12 when registering as a user, and the server computer 12 stores the user information to the user database 12B. Here, it is optional for the user computer 16 to install the decoding program in advance, and if the user computer 16 does not install the decoding program, the user computer 16 is connected to the server computer 16 to perform a series of processes for decoding, which will be explained later.

A a code image contained in an advertising image, which is distributed by an advertiser in a physical form or an electronical form is input, to the user computer 16 in step 72. The user computer 16 can receive the code image using an image input apparatus 15, or load an already-made image file to the memory through a storage device such as a disc or a buffer. If the advertising image is distributed in the form of a printed image on a magazine or a newspaper, the advertising image is input through the image input apparatus 15 to the user computer 16, converted into code data formed of computer readable data, and then the code data is input to the user computer 16.

The user computer 16 decodes the code data using an already installed decoding program to extract predetermined code information contained the code image in step 73. Here, examples of extracted information are shown in FIGS. 4A or 4B, which is formed of characters or numbers. If the user computer 16 does not install the decoding program, the user computer 16 transmits code data to the server computer 12 and the server computer 12 decodes the code data.

After decoding, the type of code information is determined. Code information type may be address information or index information. If the code information is address information, a service program is executed according to service information, a network apparatus is connected using the address information, thereby providing services. If the code information is index information, the address database in the server is connected and address information related to the index information is sought using an index searching method. Then, according to the address information, services are provided. This process will now be explained in details.

Whether the code information is address information or index information is determined in step 74, by checking the content included in the code information, based on the presence of dots, or special characters (for example, colon or slash), or the number of characters. Meanwhile, flag information to determine whether the code information is address information or index information can be included in the code information. If the code information is address information, a network address or URL according to the address information is set as network information in step 77. If the code information is index information, the user computer 16 transmits the index information to the server computer 12, and the server computer 12 searches the address database 12B for address information corresponding to the index information and transmits the address information to the user computer 16 in step 75. The user computer 16 sets address information transmitted from the server computer 12 as network information in step 76.

Then, service information is set in step 78. If the code information contains service information, the service information is set as target service information, and otherwise, service information is set as basically defined by default. According to address information and service information, the user computer 16 executes the service program in step 79, accesses a corresponding network apparatus in step 80, and receives services which the advertiser wants to provide to users through the advertising image in step 81. Also, the network address obtained as a result of decoding can be stored in the user computer in the form of a bookmark.

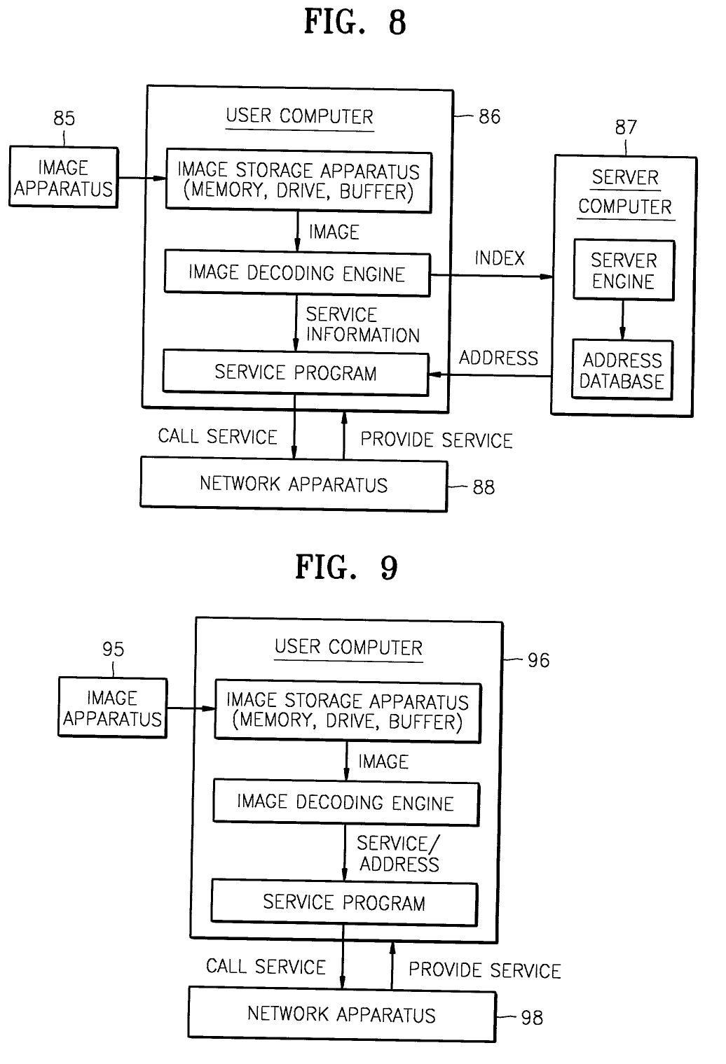

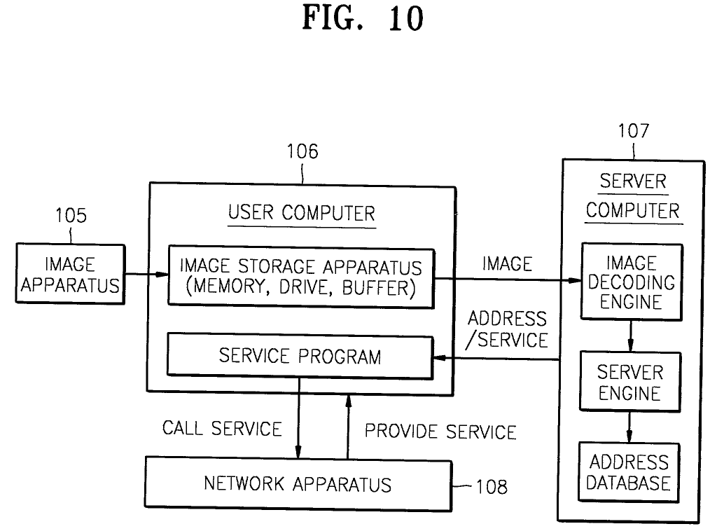

FIGS. 8 through 10 are schematic diagrams of various examples of the decoding method in the method explained in FIG. 7. FIGS. 8 and 9 show user-based decoding methods and can be divided into an index-type decoding method (FIG. 8) and a direct decoding method (FIG. 9). FIGS. 8 and 9 show examples in which the user computer 16 downloads and installs a decoding program from the server computer in advance and the user computer 16 decodes a code image. FIG. 10 shows a server-based decoding method, in which the user computer 16 does not install the decoding program and the server computer decodes a code image.

Referring to FIG. 8, the user computer 86 receives a code image through an image input apparatus 85, and the code image is stored in an image storage apparatus such as a memory or a disc. The code image is decoded to code information by an image decoding engine, and at this time the code information includes index information, and optionally service information. Then, the index information is transmitted to the server computer 87, the server engine searches the address database for address information corresponding to the index information, and then the address information is transmitted to the user computer 86. The user computer 86 operates the service program according to address information and service information, calls the services from the network apparatus 88, and then receives services.

Referring to FIG. 9, the user computer 96 receives a code image through the image input apparatus 95, and the code image is stored in an image storage apparatus. The code image is decoded into code information by an image decoding engine, and at this time, the code information includes address information and optionally service information. Then, the user computer 96 operates the service program according to address information and service information, and calls the services from the network apparatus 98, and then receives services. In this case, the user computer 96 need not directly access the server computer to receive advertising services.

Referring to FIG. 10, the user computer 106 receives a code image through the image input apparatus, the code image is stored in an image storage apparatus such as a memory or a disc. The code image is transmitted to the server computer 107 and decoded to code information by the image decoding engine. If the code information is index information (index-type decoding method), the server computer 107 searches the address database for address information corresponding to the index information. The server computer 107 transmits address information and service information to the user computer 106. The user computer operates the service program according to address information and service information, calls services from the network apparatus 108, and then receives services.

The present invention may be embodied in a code, which can be read by a computer, on a computer readable recording medium. The computer readable recording medium may be any kind on which computer readable data are stored. The computer readable recording media may be storage media such as magnetic storage media (e.g., ROM's, floppy disks, hard disks, etc.), optically readable media (e.g., CD-ROMs, DVDs, etc.), or carrier waves (e.g., transmissions over the Internet). Also, the computer readable recording media can be scattered on computer systems connected through a network and can store and execute a computer readable code in a distributed mode.

As described above, according to the advertising method of the present invention, information for providing network services related to advertisements is physically or electronically represented by a code image in various advertising media, and a user can directly get network services provided by the advertiser, by clicking on the image or scanning or photographing the image with an optical input apparatus. That is, using a PC camera, a digital camera or a scanners, which is already widely used, a code image contained in an advertisement is input to a computer, and then, using the shape, colors, or pattern information of the code image, the code image can be decoded into useful information such as an address or a URL on a predetermined network, according to a predetermined code system, and corresponding advertising services can be received using the information.

According to the present invention, by mapping information contained in an image into an address of a network, networks services can be easily received using physically or electronically represented pictures or characters. For example, if a code image in which a URL is encoded is photographed using a PC camera, the corresponding network can be immediately accessed and advertising services can be provided. Also, since already-made code images can be stored in a storage device, the code images can be clicked on to receive advertising services, when necessary.

What is claimed is:

1. An advertising method comprising the steps of:
the advertiser transmitting address information for providing services of a predetermined advertisement to a server;
the server assigning index information to the address information and storing the address information and index information; and
converting the address information or index information into a code image, which can be physically or electronically represented, by encoding the address information or index information using an encoding algorithm provided from the server.

2. The advertising method of claim 1, further comprising the step of:
distributing the code image in a printed state on a medium, in the form of a computer readable electronic file, in a state displayed on a screen, or in a state which can be input through an optical apparatus.

3. The advertising method of claim 1, wherein the code image includes a data area formed of at least one or more data cells each of which is represented by colors or shades according to the content of information to be encoded.

4. The advertising method of claim 3, wherein the code image further comprising at least one or more among:
a parity area, which is formed of at least one or more parity cells, for providing parity information for confirming whether or not the colors or shades read from the data cells are correctly recognized during decoding;
a reference area, which is formed of at least one or more reference cells, for providing base colors or base shades for determining the colors or shades of data cells formed in the data area; and
a control area, which is formed of at least one or more control cells, for representing commands or services which can be provided by the information represented in the data area.

5. The advertising method of claim 3, wherein in converting characters or numbers into an image to be represented in a cell in the data area, a pattern including a vector line as well as colors or shades is used, or colors or shades are differently represented after dividing a cell horizontally, vertically, or diagonally.

6. An advertising method comprising the steps of:
converting a code image related to an advertisement into computer readable code data;
decoding the code data by a decoding algorithm and extracting code information contained in the code image; and
executing a service program according to the code information and providing services preset for the advertisement.

7. The advertising method of claim 6, wherein the code image is an image formed of shapes, colors, patterns, or their combinations generated by converting one or more characters or numbers contained in the code information according to a predetermined code conversion table which maps each character and number to a predetermined color or shade.

8. The advertising method of claim 6, wherein the code information includes a network address related to the advertisement and service information related to services which can be provided by the network address.

9. The advertising method of claim 6, wherein the code information extracting step further comprises the sub-steps of:
installing a decoding program to a user computer; and
the user computer decoding the code data using the decoding program and extracting code information contained in the code image.

10. The advertising method of claim 6, wherein the code information extracting step further comprises the sub-steps of:
transmitting the code data from the user computer to the server;
the server decoding the code data using the decoding program and extracting code information contained in the code image; and
transmitting the code information from the server to the user computer.

11. The advertising method of claim 6, wherein the code information extracting step further comprises the sub-steps of:
transmitting index information to the server if the code information includes the index information; and
the server extracting code information corresponding to the index information and providing the code information to the user computer.

12. An advertising service apparatus comprising:
a program wherein an algorithm for encoding and decoding code information is implemented;
an advertiser interface which is connected to an advertiser computer through a communication network, transmits the encoding program in response to the request from the advertiser computer, receiving address information related to an advertisement from the advertiser, and assigning index information corresponding to the address information;
a user interface which is connected to a user computer through a communication network, transmits the decoding program in response to the request from the user computer, extracting code information from a code image transmitted from the user computer, and providing the code image to the user computer; and
a database for storing the address information and index information assigned corresponding to the address information, wherein the user computer is allowed to receive advertising services related to the advertisement according to the address information or index information.

13. The advertising service apparatus of claim 12, wherein the advertiser interface further comprises an image converting means for converting the address information or index information into a code image physically or electronically represented, by encoding the address information or index information.

14. An advertising service apparatus comprising:
a data processing unit for processing data by an algorithm for encoding and decoding data;
an image generating unit for generating a code image physically or electronically represented by the encoding algorithm, using address information related to an advertisement as code information;
a data generating unit for generating code data by converting the code image generated in the image generating unit into computer readable data; and
a service providing unit for extracting code information by decoding the code data generated in the data generating unit by the decoding algorithm, and providing advertising services related to the advertisement according to the address information set by the code information.

15. The advertising service apparatus of claim 14, wherein the data processing unit further comprises a database for storing the address information and index information corresponding to the address information and if code information input to the service providing unit is index information, the service providing unit receives address information, which is stored in the database referred to by the index information.

16. An advertising method comprising the steps of:
assigning index information related to address information for providing advertising services;
storing the address information and index information;
converting the index information into a code image which can be physically or electronically represented, by encoding the index information by an encoding algorithm; and
generating an advertising image wherein the code image is physically or electronically represented together with the content image related to the advertisement.

17. A computer readable recording medium which stores a program for executing a method, wherein the method comprises the steps of:
the advertiser transmitting address information for providing services of a predetermined advertisement to a server;
the server assigning index information to the address information and storing the address information and index information; and
converting the address information or index information into a code image, which can be physically or electronically represented, by encoding the address information or index information using an encoding algorithm provided from the server.

18. A computer readable recording medium which stores a program for executing a method, wherein the method comprises the steps of:
converting a code image related to an advertisement into computer readable code data;
decoding the code data by a decoding algorithm and extracting code information contained in the code image; and
executing a service program according to the code information and providing services preset for the advertisement.

19. A computer readable recording medium which stores a program for executing a method, wherein the method comprises the steps of:
assigning index information related to address information for providing advertising services;
storing the address information and index information,
converting the index information into a code image which can be physically or electronically represented, by encoding the index information by an encoding algorithm; and
generating an advertising image wherein the code image is physically or electronically represented together with the content image related to the advertisement.
